(19) United States
(12) Patent Application Publication
(10) Pub. No.: US 2025/0388129 A1
(43) Pub. Date: Dec. 25, 2025

(54) FUEL CELL-POWERED CRAWLER VEHICLE AND CONTROL METHOD THEREOF

(71) Applicant: PRINOTH S.P.A., Vipiteno (IT)

(72) Inventors: Jamie Thom, Vipiteno (IT); Martin Kirchmair, Vipiteno (IT)

(21) Appl. No.: 19/240,669

(22) Filed: Jun. 17, 2025

(30) Foreign Application Priority Data
Jun. 19, 2024 (IT) 102024000014110

(51) Int. Cl. B60L 58/30; B60K 1/04

(52) U.S. Cl. CPC B60L 58/30; B60K 1/04; B60L 2200/40; B60L 2240/642

(57) ABSTRACT

A fuel cell-powered crawler vehicle has a chassis extending along a longitudinal axis; a housing integral with the chassis configured to house fuel cells; and a compensating device configured to incline the fuel cells inside the housing in the opposite direction to the inclination assumed by the chassis of the crawler vehicle when the crawler vehicle is in operation along steep ski slopes.

### PRIORITY CLAIM

This application claims the benefit of and priority to Italian Patent Application No. 102024000014110, filed on Jun. 19, 2024, the entire contents of which is incorporated by reference herein.

### TECHNICAL FIELD

The present disclosure relates to a fuel cell-powered crawler vehicle.

### BACKGROUND

Fuel cells are used in various fields as an energy source. In the field of locomotion, fuel cell applications power several types of vehicles such as cars, motorcycles, buses, trains, boats, etc.

The growing need to reduce the environmental impact and, consequently, the consumption of fossil fuels is driving researchers to apply environmentally-friendly solutions in fields that have not yet been fully explored, such as the field of crawler vehicles.

Some types of crawler vehicles, such as snow groomer vehicles, are designed to adequately groom ski runs, and for this reason, for a considerable amount of the time in use, they are found on slopes that are sometimes also particularly relatively steep, with gradients even greater than 70%. Similarly, crawler vehicles for managing vegetation may be used along relatively extremely steep slopes.

The operating conditions of the crawler vehicles do not favor the use of fuel cells as an energy source because fuel cell operation is optimal in terms of efficiency when the fuel cells have a predetermined orientation that favors the oxidation reaction and the evacuation of products from the oxidation reaction.

### SUMMARY

An object of the present disclosure is to manufacture a fuel cell-powered crawler vehicle that is free from certain of the drawbacks of certain of the prior art.

In accordance with certain embodiments of the present disclosure, a fuel cell-powered crawler vehicle is manufactured, the crawler vehicle comprising a chassis extending along a longitudinal axis; and a compensating device configured to incline the fuel cells in the opposite direction to the inclination assumed by the chassis of the crawler vehicle when the crawler vehicle is in operation along steep ski slopes. In these embodiments, it is possible to arrange the fuel cells in plane or, in the worst case, with a relative slight inclination which does not affect the performance of the fuel cells.

In certain embodiments, the compensating device comprises a support configured to support the fuel cells; and at least one connecting coupling configured to connect the support to the chassis and enable or otherwise allow the support to swing relative to the chassis about a pitch axis transverse to the longitudinal axis and a roll axis parallel to the longitudinal axis.

In principle of certain embodiments, it is sufficient to hang the support from the chassis or from some structural element integral with the chassis to enable the support to compensate for the inclination of the chassis by the force of gravity.

In certain embodiments, the compensating device comprises at least one damper for connecting the support to the chassis and preventing oscillations of the fuel cells.

According to certain embodiments of the present disclosure, the compensating device comprises a plurality of actuators for controlling the position of the fuel cells as a function of signals related to the inclination of the chassis of the crawler vehicle. In this case, the movement and the speed of the movement of the fuel cells are under control.

In certain embodiments, the compensating device comprises a power unit for selectively powering the actuators as a function of the signals. In this case, there are four linear actuators constrained to the chassis and to the support by means of ball joints or the like.

In certain embodiments, the crawler vehicle comprises a control unit configured to emit the signals as a function of signals related to the inclination of the chassis of the crawler vehicle. In this case, the crawler vehicle comprises a first inclinometer configured to acquire a signal related to the longitudinal inclination of the chassis of the crawler vehicle and transmit the signal to the control unit, and a second inclinometer configured to acquire a signal related to the lateral inclination of the chassis of the crawler vehicle and transmit the signal to the control unit. In this manner, any inclination assumed by the chassis can be compensated in a controlled manner.

In certain embodiments, the crawler vehicle comprises a housing integral with the chassis and configured to house the fuel cells and enable or otherwise allow the fuel cells to assume inclined configurations with respect to the housing.

In practice, the housing is dimensionally abundant around the support and fuel cells to enable or otherwise allow relative inclinations between the fuel cell, on one side, and the housing, on the other side.

A further object of the present disclosure is to provide a control method of a fuel cell-powered crawler vehicle that is free from certain of the drawbacks of certain of the prior art.

In accordance with the present disclosure, a control method of a fuel cell-powered crawler vehicle is provided, the method comprising supporting the fuel cells in a movable manner relative to the chassis so as to enable or otherwise allow the fuel cells to assume an inclination in the opposite direction to the inclination assumed by the chassis.

### BRIEF DESCRIPTION OF THE FIGURES

Further features and advantages of the present disclosure will become clear from the following description of non-limiting examples of embodiments, with reference to the accompanying Figures:

FIG. 1 is a side elevation view, with parts removed for clarity and schematic parts, of a crawler vehicle manufactured in accordance with the present disclosure;

FIG. 2 is a schematic elevation view, with parts removed for clarity and in an enlarged scale, of a detail of the crawler vehicle of FIG. 1;

FIG. 3 is a schematic plan view, with parts removed for clarity, of the detail of FIG. 2;

FIG. 4 is a schematic elevation view, with parts removed for clarity, of a further embodiment of the detail of FIG. 2; and

FIG. 5 is a schematic plan view, with parts removed for clarity, of the detail of FIG. 4.

### DETAILED DESCRIPTION

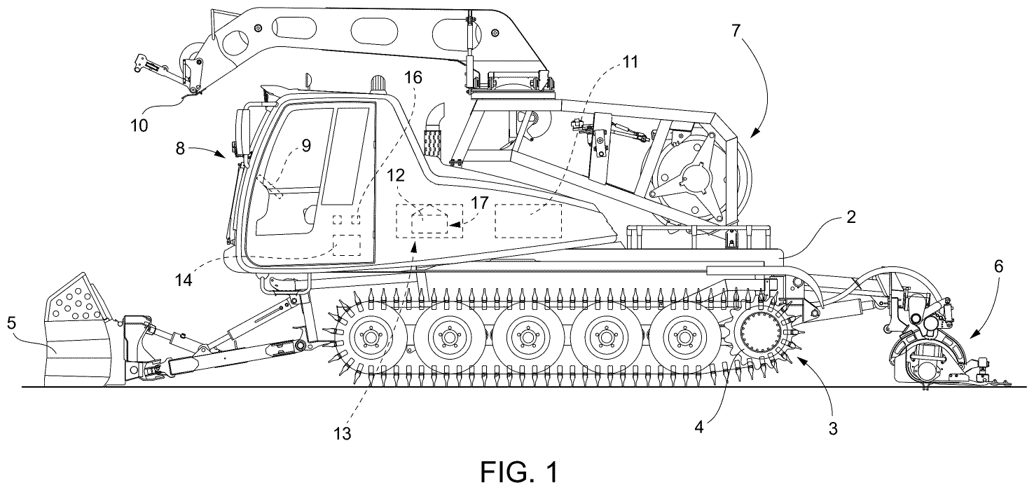

With reference to FIG. 1, reference numeral 1 indicates, as a whole, a crawler vehicle configured to groom ski runs. The crawler vehicle 1 comprises a chassis 2; two tracks 3; two drive wheels 4 independent of each other and respectively coupled to respective tracks 3; a shovel 5; a cutter 6; and a winch 7; a cabin 8 mounted on the chassis 2; and a user interface 9 arranged inside the cabin 8 and comprising driving and control instrumentation.

The winch 7 is mounted on the chassis 2 to selectively unwind and wind a cable 10 anchorable at an external point (not depicted in the drawings) to the crawler vehicle 1 to secure the crawler vehicle when the crawler vehicle faces relatively particularly steep ascents and descents.

The crawler vehicle 1 comprises an electric engine 11 powered by fuel cells 12. In this case, the crawler vehicle 1 comprises a housing 13 configured to contain the fuel cells 12.

The crawler vehicle 1 comprises a control unit 14 configured to manage the operations of the crawler vehicle 1 and connected with the user interface 9.

The crawler vehicle 1 comprises a plurality of sensors configured to emit signals that are transmitted to the control unit 14. The sensors comprise an inclinometer 15 configured to acquire signals related to the longitudinal inclination (pitch) and an inclinometer 16 configured to acquire signals related to the lateral inclination (roll) of the crawler vehicle 1.

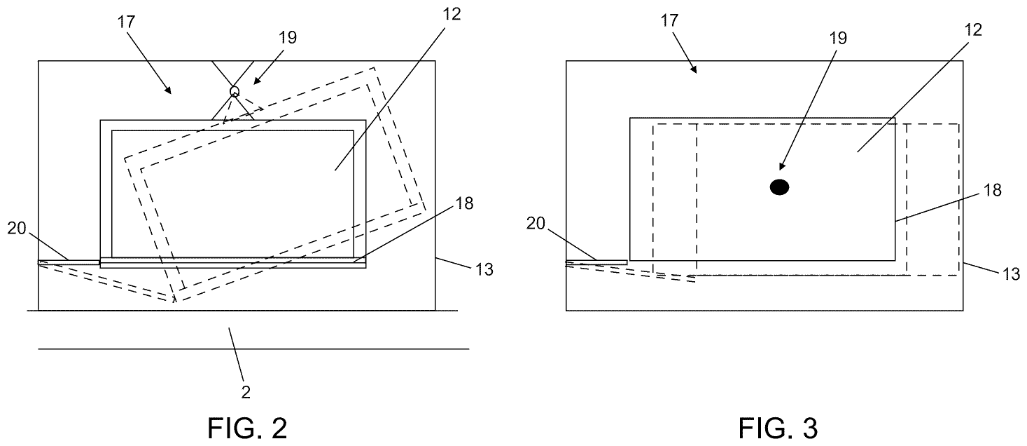

With reference to FIG. 2, a compensating device 17 is arranged in the housing 13, and is constrained in a movable manner to the housing 13 and is configured to support the fuel cells 12.

In the embodiment of FIGS. 2 and 3, the compensating device 17 comprises a support 18 hanging from the housing 13 and a coupling 19 that constrains the support 18 to the housing 13 and enables the support 18 and the fuel cells 12 to swing in any direction.

The housing 13 is dimensioned to enable or otherwise allow the support 18 and the fuel cells 12 to perform oscillations comprised the range from −30° to 30° in the longitudinal direction (pitch) and in the range from −15° to 15° in the transverse direction (roll).

The compensating device 17 comprises a damper 20 connected to the housing 13 and to the support 18 to prevent relative abrupt movements of the support 18 and the relative fuel cells 12.

In use, when the crawler vehicle 1 depicted in FIG. 1 travels ski runs with relatively steep gradients, generally ski runs classified as black have a gradient greater than 40%, the support 18 and the fuel cells 12 as a result of the force of gravity assume a horizontal configuration and form an angle relative to the housing 13 to compensate mainly the longitudinal inclination (pitch) and lateral inclination (roll).

It should be noted that an inclination of 30° corresponds to a gradient of 58%, so that the compensating device 17 is able to compensate longitudinal gradients up to gradients of the order of 58%.

In any case, it is considered tolerable to incline the fuel cells 12 up to values of +/−15° so that the crawler vehicle powered with fuel cell batteries is suitable for any type of ski run.

As shown in the Figures, the lateral inclination (roll) generally assumes much more limited gradients.

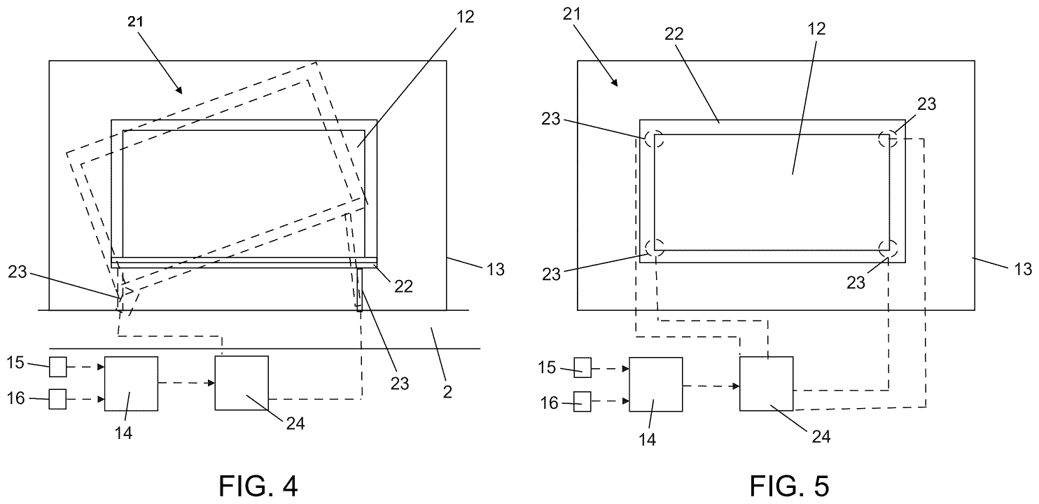

With reference to FIGS. 4 and 5, the crawler vehicle 1 comprises a compensating device 21 comprising a support 22 configured to support the fuel cells 12, a plurality of actuators 23 configured to connect the housing 13 to the support 22, and a power unit 24 configured to actuate the actuators 23 as a function of the signals transmitted by the control unit 14 as a function of the signals acquired by the inclinometers 15 and 16.

To enable or otherwise allow inclining the support, each actuator 23 is connected by ball joints or similar to both the housing 13 and the support 22 to enable the support 22 full freedom of movement.

In use, the compensating device 21 controls the longitudinal inclination (pitch) and lateral inclination (roll) of the support 22 in a manner equal and opposite to the inclination assumed by the crawler vehicle up to a maximum permissible value.

It is apparent that variations may be made to the present disclosure without departing from the scope of protection of the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention claimed is:

1. A fuel cell-powered crawler vehicle comprising:
a chassis extending along a longitudinal axis; and
a compensating device configured to incline a fuel cell in an opposite direction to an inclination assumed by the chassis when the fuel cell-powered crawler vehicle is in operation along a ski slope having a gradient greater than 40%.

2. The fuel cell-powered crawler vehicle of claim 1, wherein the compensating device comprises:
a support configured to support the fuel cell; and
a connecting coupling configured to connect the support to the chassis and enable the support to swing relative to the chassis about a pitch axis transverse to the longitudinal axis and a roll axis parallel to the longitudinal axis.

3. The fuel cell-powered crawler vehicle of claim 1, wherein the compensating device comprises a damper configured to connect the support to the chassis.

4. The fuel cell-powered crawler vehicle of claim 1, wherein the compensating device comprises a plurality of actuators configured to control a position of the fuel cell as a function of a signal related to the inclination of the chassis.

5. The fuel cell-powered crawler vehicle of claim 4, wherein the compensating device comprises a power unit configured to selectively power the plurality of actuators as a function of the signal.

6. The fuel cell-powered crawler vehicle of claim 5, further comprising a control unit configured to emit the signal.

7. The fuel cell-powered crawler vehicle of claim 6, further comprising a first inclinometer configured to acquire a signal related to the longitudinal inclination of the chassis and transmit that signal to the control unit.

8. The fuel cell-powered crawler vehicle of claim 6, further comprising a second inclinometer configured to acquire a signal related to the lateral inclination of the chassis and transmit that signal to the control unit.

9. The fuel cell-powered crawler vehicle of claim 1, further comprising a housing integral with the chassis and configured to house the fuel cell and enable the fuel cell to assume an inclined configuration relative to the housing.

10. A method of controlling a crawler vehicle powered by a fuel cell, the method comprising moveably supporting the fuel cell relative to a chassis to enable the fuel cell to assume an inclination in an opposite direction to an inclination assumed by the chassis of the crawler vehicle.

11. The method of claim 10, further comprising damping a displacement of the fuel cell relative to the chassis of the crawler vehicle.

12. The method of claim 10, further comprising controlling the inclination of the fuel cell by a plurality of actuators as a function of a signal related to the inclination of the chassis of the crawler vehicle.
